(19) United States
(12) Patent Application Publication
(10) Pub. No.: US 2015/0152265 A1
(43) Pub. Date: Jun. 4, 2015

(54) BITUMINOUS COMPOSITIONS COMPRISING ADDITIVES, HAVING IMPROVED THERMOREVERSIBLE PROPERTIES

(71) Applicant: TOTAL MARKETING SERVICES, Puteaux (FR)

(72) Inventors: Dominique Basset, Saint Clair Du Rhône (FR); Régis Vincent, Grigny (FR)

(73) Assignee: TOTAL MARKETING SERVICES, Puteaux (FR)

(21) Appl. No.: 14/412,038

(22) PCT Filed: Jun. 28, 2013
(86) PCT No.: PCT/EP2013/063599

§ 371 Date: Dec. 30, 2014

(30) Foreign Application Priority Data
Jul. 2, 2012 (FR) 12/56320

(51) Int. Cl. C08L 95/00; C08K 5/00

(52) U.S. Cl. CPC C08L 95/00; C08K 5/00; C08L 2555/60

(57) ABSTRACT

The disclosure relates to a bituminous composition and to the method of preparation thereof. The bituminous composition includes a bitumen, a first additive comprising at least one fatty acid ester function, saturated or unsaturated, linear or branched, having a hydrocarbon chain with 4 to 36 carbon atoms, optionally substituted by at least one hydroxyl group and a second additive comprising at least one organogelator. The disclosure also relates to the use of a combination of the first additive and of the second additive in a bituminous composition, for improving the susceptibility to temperature of the composition. Finally, the disclosure relates to the use of these bituminous compositions in the fields of highway applications, in particular in the manufacture of highway binders, and in the fields of industrial applications.

### CROSS-REFERENCE TO RELATED APPLICATIONS

This application is a National Phase Entry of International Application No. PCT/EP2013/063599, filed on Jun. 28, 2013, which claims priority to French Patent Application Serial No. 1256320, filed on Jul. 2, 2012, both of which are incorporated herein by reference.

### TECHNICAL FIELD

The present invention relates to the field of bitumens, in particular bituminous compositions. The invention relates to bituminous compositions and the method of preparation thereof. Moreover, the subject of the present invention relates to the use of additives in a bituminous composition or a bitumen base for improving their thermoreversible and rheological properties, in particular, for cross-linking said bituminous composition or bitumen base thermoreversibly and/or for improving the susceptibility to temperature of bituminous compositions. The invention also relates to the use of these bituminous compositions in the fields of highway applications, in particular in the manufacture of highway binders, and in the fields of industrial applications.

### BACKGROUND

The use of bitumen in the manufacture of materials for highway and industrial applications has long been known: bitumen is the main hydrocarbon binder used in the field of highway construction or civil engineering. For use as a binder in these various applications, bitumen must have some particular physicochemical properties. One of the most important properties is the consistency of bitumen; this must be high enough at the temperatures of use to avoid the formation of ruts caused by traffic.

The bitumen must also be elastic to resist the deformations imposed by traffic and/or changes in temperature, phenomena which lead to cracking of the bituminous mixes or to stripping of the surface aggregates. Finally, the bitumen must be sufficiently fluid at the lowest possible temperatures of application to allow good coating of the aggregates and placement of the bituminous mix on the road as well as compacting thereof with the current technical means of the highway profession. The implementation of a bituminous binder therefore requires combining both the hardness and the elasticity of bitumen at the temperatures of use and low viscosity at the temperatures of application. As bitumen on its own is not generally sufficiently elastic, polymers, which may optionally be cross-linked, are added to the bitumen. These cross-linked polymers give the bituminous compositions greatly improved elastic properties and stability in storage.

However, when hot, addition of polymers to the bituminous composition leads as a general rule to an increase in viscosity of the bituminous composition. To be suitable for application on the carriageway, the bituminous binder with added polymers will therefore have to be heated to an application temperature higher than that of a bituminous binder without polymers. This runs counter to the objectives of saving energy, lowering the temperatures of use, reducing emissions of fumes on the construction site and worker protection.

Cross-linking according to the prior art is in most cases irreversible cross-linking based on the formation of covalent bonds between the polymers. Thus, one of the forms of cross-linking most used in the field of bitumens is cross-linking with sulphur or vulcanization. The applicant has developed and patented a certain number of cross-linked bituminous compositions having properties that are greatly improved relative to bitumen without polymers and relative to the non-cross-linked bitumen/polymer physical mixture. Among the applicant's patents, there may be mentioned in particular the following references: FR2376188, FR2429241, EP0799280, EP0690892.

Recently, in two patent applications WO2008107551 and WO2009101275, the applicant described a new method of reversible cross-linking of bituminous compositions, based on the use of organogelling additives. The applicant in particular showed that the organogelling additive may be assimilated to a “supramolecular” polymer and imparts to bitumen with properties equivalent to those of a conventional bitumen/polymer composition, in particular with respect to hardness, while reducing the high-temperature viscosity. The thermoreversibly cross-linked bituminous compositions thus obtained are hard at the temperatures of use and have reduced viscosity at the application temperatures.

Continuing this work, the applicant looked for other compounds allowing bitumens to be hardened at the temperatures of use without increasing their high-temperature viscosity. A further objective of the applicant is to propose new additives capable of improving the rheological properties of a bituminous composition or of a bitumen base, in particular for adjusting the mechanical characteristics of said composition or bitumen base depending on the applications for which the composition is intended.

The mechanical properties of bituminous compositions are generally assessed by determining a series of mechanical characteristics using standardized tests, those used most widely being the softening point determined by the ring and ball test, also called the ring and ball softening point and denoted by RBT, and needle penetration expressed in 1/10 of mm. An indication of the susceptibility to temperature of bituminous compositions can also be obtained from a correlation between the needle penetration and the RBT of said compositions, known as the penetration index or Pfeiffer index, denoted by PI. The susceptibility to temperature of the bituminous composition decreases as the PI value increases. Low susceptibility to temperature ensures good mechanical behaviour over the temperature range of use of said composition. The applicant therefore concentrated on the effect of additives on the penetration index (or Pfeiffer index, denoted PI), the softening point determined by the ring and ball test (according to standard EN 1427), needle penetration expressed in 1/10 of mm (according to standard EN 1427), and/or the dynamic viscosity of the bituminous compositions, at a temperature above or equal to 80° C., preferably above 80° C., more preferably above or equal to 120° C.

The invention relates in particular to thermoreversibly cross-linked bituminous compositions, i.e. having, at the temperatures of use, the properties of conventional bituminous compositions with respect to hardness, and having reduced viscosity at the application temperatures. Another object of the invention is to propose a simple method for preparing thermoreversibly cross-linked bituminous compositions. According to the invention, this object is achieved with thermoreversibly cross-linked bituminous compositions with improved rheological properties, in particular having low susceptibility to temperature.

In particular, the bituminous composition according to the invention comprises:
a bitumen,
a first additive comprising at least one ester function of saturated or unsaturated fatty acid, having a hydrocarbon chain with 4 to 36 carbon atoms, linear or branched, optionally substituted by at least one hydroxyl group,
a second additive comprising at least one organogelator of the following general formula (I) or (II):

R₁—(NH)ₙCONH—(X)ₘ—NHCO(NH)ₙ—R₂ (I)

in which:
the groups R₁, R₂ and/or X are identical or different and represent independently a saturated or unsaturated, linear or branched, cyclic or acyclic hydrocarbon chain with 4 to 36 carbon atoms and optionally at least one heteroatom, and
n and m are integers having a value of 0 or 1 independently of one another.
   the sorbitol derivatives of the following general formula (II):

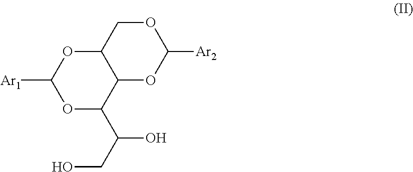

in which Ar₁ and Ar₂ are identical or different and represent a C₅-C₈ monocyclic aromatic ring or C₆-C₁₄ condensed polycyclic ring, optionally substituted by at least one group selected from halogens, hydroxyl group, primary amine group, sulphydryl group and C₁-C₈ hydrocarbon chains, saturated or unsaturated, linear or branched, optionally comprising at least one heteroatom selected from O, N and S, preferably O.

According to a particular development, the bituminous composition is cross-linked thermoreversibly. According to a particular embodiment, the first additive has a general formula (III) as follows:

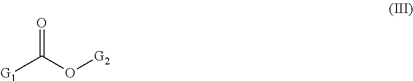

in which
G₁ represents a saturated or unsaturated, linear or branched aliphatic hydrocarbon chain with 4 to 36 carbon atoms, optionally substituted by at least one hydroxyl group,
G₂ represents a saturated or unsaturated, linear or branched aliphatic hydrocarbon chain with 1 to 188 carbon atoms, optionally comprising at least one ester function and/or at least one hydroxyl group.

Preferably, G2 comprises at least one ester function. According to a preferred variant, G2 comprises at least one ester function and at least one hydroxyl group.

According to a preferred particular embodiment, the first additive is selected from the group consisting in the saturated or unsaturated mono-, di-, tri-, tetra-, penta- and hexa-esters of fatty acid, comprising at least one linear or branched hydrocarbon chain with 4 to 36 carbon atoms, optionally substituted by at least one hydroxyl group. Preferably, the first additive is selected from the group consisting in the mono-, di- and tri-glycerides of fatty acids, the mono-, di- and tri-glycerides of hydroxy fatty acids, the fatty acid mono-, di-, tri- and tetra-esters of pentaerythritol (PET) and the fatty acid mono-, di-, tri-, tetra-, penta- and hexa-esters of dipentaerythritol (diPET). Advantageously, the first additive is selected from the triglycerides of fatty acids comprising three hydrocarbon chains, identical or different, each independently having from 4 to 36 carbon atoms, saturated or unsaturated, linear or branched, optionally substituted by at least one hydroxyl group.

According to a particular embodiment, the organogelator is represented by formula (I), in which n and m have a value of 0, and comprises a hydrazide unit. According to a development of the invention, the organogelator is represented by formula (I) in which:
R₁ and R₂ are identical or different and comprise independently a C₅-C₈ monocyclic aromatic ring or C₆-C₁₄ condensed polycyclic ring, preferably C₈-C₁₂, said monocyclic aromatic or condensed polycyclic ring optionally being substituted by at least one group selected from halogens, hydroxyl group, primary amine group, sulphydryl group and C₁-C₈ hydrocarbon chains, linear or branched, saturated or unsaturated, preferably saturated, optionally comprising at least one heteroatom selected from O, N and S, preferably O, and
n and m have a value of 0.

According to another particular embodiment, the organogelator is represented by formula (I) in which n has a value of 0 and m has a value of 1, and comprises two amide units. According to a development of the invention, the organogelator is a fatty acid diamide represented by formula (I) in which n has a value of 0, m has a value of 1 and X represents the group —(CH₂)ₚ— with p being comprised between 1 and 8, preferably between 1 and 4. Advantageously, R₁ and R₂ are identical or different and represent, independently, a saturated, acyclic, linear or branched hydrocarbon chain with 4 to 36 carbon atoms, and optionally at least one heteroatom. The organogelator is preferably N,N′-ethylene-bis(stearamide).

According to another particular embodiment, the organogelator is represented by formula (I), in which n and m have a value of 1, and comprises two urea units. In particular, the preferred organogelator is represented by formula (II) in which Ar₁ and Ar₂ are identical or different and represent independently a C₅-C₈ monocyclic aromatic ring, optionally substituted by at least one group selected from halogens, hydroxyl group, primary amine group, sulphydryl group and the C₁-C₈ saturated hydrocarbon chains, linear or branched, optionally comprising at least one heteroatom selected from O, N and S, preferably O. Advantageously, the organogelator represented by formula (II) is 1,3:2,4-di-O-benzylidene-D-sorbitol. Preferably, the bituminous composition comprises from 0.1 to 10% by weight of the first and second additives relative to the weight of bitumen.

In these earlier works (WO2008107551 and WO2009101275), the applicant showed that adding of an organogelator made it possible to harden the bituminous composition without increasing the high-temperature viscosity of the bituminous composition. The applicant was able to demonstrate that the combination of a first specific additive and a second specific additive comprising a particular organogelator has a quite unexpected synergistic effect on the susceptibility to temperature of the bituminous composition, in particular on the PI index and, advantageously, on the RBT while maintaining the hardening effect of the organogelator mentioned in the patent applications of the prior art (WO2008107551). The bituminous compositions according to the invention rectify the drawbacks of the prior art and meet the objectives of the invention.

The combined presence of the first and second additives surprisingly imparts to said compositions with improved mechanical and rheological properties, in particular an unexpected increase of the penetration index (PI). It will be demonstrated later on in the description that such a combination of additives makes it possible, moreover, to decrease the needle penetration while significantly increasing the PI index and, advantageously, on the RBT not only relative to the initial bitumen base but also, quite surprisingly, relative to a bituminous composition comprising either the first additive or the second additive of the organogelator type.

The invention further relates to the use of such a bituminous composition according to the invention for producing a bituminous binder, in particular a synthetic binder, an anhydrous binder, a bituminous emulsion, a polymeric bitumen or a fluxed bitumen. The invention also relates to a method of preparing such a bituminous composition according to the invention, in which the first and second additives are added, at temperatures in the range from 140 to 180° C., either to the bitumen alone, to the bitumen whether or not modified with polymers, to the bitumen in the form of bituminous binder or to the bitumen when the latter is in the form of synthetic binder, anhydrous binder, bituminous mix, or surface dressing, or during manufacture of said bitumen, bituminous mixes, binders or dressings. According to the invention, this object is also achieved with a bituminous mix comprising such a composition according to the invention, aggregates of bituminous mixes and mineral and/or synthetic fillers.

The invention also relates to the use of a combination of a first additive and a second additive as described above in a bituminous composition or bitumen base, for thermoreversibly cross-linking said composition or base, preferably while increasing the penetration index (or Pfeiffer index, PI) of said composition or bitumen base. According to a development of the invention, the use of such a combination makes it possible to increase the softening point of the bituminous composition or bitumen base determined by the ring and ball test according to standard EN 1427 (RBT). In particular, when the organogelator is represented by general formula (I), the use of such a combination makes it possible to decrease the needle penetration at 25° C., calculated according to standard EN 1426. According to another development of the invention, the use of such a combination makes it possible both to increase the softening point determined by the ring and ball test according to European standard EN 1427 (RBT) and the penetration index (Pfeiffer index, PI), and to lower the dynamic viscosity of the bituminous composition or bitumen base, at a temperature above or equal to 80° C., preferably above 80° C., more preferably above or equal to 120° C., when the organogelator is represented by formula (I) in which n has a value of 0 and m has a value of 1, and comprises two amide units.

### DETAILED DESCRIPTION

According to a particular embodiment, a bituminous composition comprises a bitumen, a first additive and a second additive comprising at least one organogelator. The bitumen used may be originate from various origins: bitumens of natural origin, those contained in deposits of natural bitumen, of natural asphalt or bituminous sands and those originating from refining of crude oil, in particular from atmospheric and/or vacuum distillation of petroleum. The bitumen may optionally be blown, visbroken and/or deasphalted. The bitumen may be a bitumen of hard grade or of soft grade. The various bitumens obtained by the refining processes may be combined with one another to obtain the best technical compromise.

The bitumen may also be a bitumen fluxed by adding volatile solvents, fluxing agents of petroleum origin and/or fluxing agents of vegetable origin. The bitumen may, moreover, be selected from special bitumens such as bitumens modified by addition of polymers. As examples of polymers for bitumen, there may be mentioned elastomers such as the polystyrene, polybutadiene or polyisoprene, SB, SBS, SIS, SBR block copolymers, the EPDM polymers, polychloroprene, polynorbornene and, optionally, the polyolefins such as polyethylenes PE, HDPE, polypropylene PP, plastomers such as EVA, EMA, copolymers of olefins and unsaturated carboxylates EBA, polyolefin-elastomer copolymers, polyolefins of the polybutene type, copolymers of ethylene and esters of acrylic acid, methacrylic acid or maleic anhydride, copolymers and terpolymers of ethylene and glycidyl methacrylate, ethylene-propylene copolymers, rubbers, polyisobutylenes, SEBS and ABS.

Preferably, however, bitumens not modified by addition of polymers will be selected. The bituminous composition preferably comprises a bitumen of soft grade, advantageously a bitumen base of grade 50/70, 70/100, 100-150, 160/220, 250-330, preferably 50/70, 70/100.

The first additive comprises at least one fatty acid ester function, saturated or unsaturated, having a linear or branched hydrocarbon chain with 4 to 36 carbon atoms, preferably with 4 to 24 carbon atoms, more preferably with 12 to 24 carbon atoms, even more preferably with 16 to 22 carbon atoms. By unsaturated fatty acid is meant a fatty acid that comprises one or more carbon-carbon double bonds. The hydrocarbon chain may optionally be substituted by at least one hydroxyl group.

According to a particular embodiment, the first additive has a general formula (III) as follows:

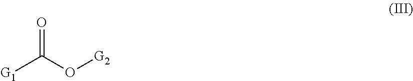

in which
G₁ represents a saturated or unsaturated, linear or branched aliphatic hydrocarbon chain with 4 to 36 carbon atoms, preferably with 4 to 24 carbon atoms, more preferably with 12 to 24 carbon atoms, even more preferably with 16 to 22 carbon atoms.
G₂ represents a saturated or unsaturated, linear or branched aliphatic hydrocarbon chain with 1 to 188 carbon atoms, optionally comprising at least one ester function and/or at least one hydroxyl group.

G₂ may contain at least one fatty acid ester function, saturated or unsaturated, preferably at least two. According to a variant, G₂ may contain at least three saturated or unsaturated fatty acid ester functions. According to another variant, G₂ may contain at least four saturated or unsaturated fatty acid ester functions. The corresponding fatty acids advantageously have a linear or branched hydrocarbon chain with 4 to 36 carbon atoms, preferably with 4 to 24 carbon atoms, more preferably with 12 to 24 carbon atoms, even more preferably with 16 to 22 carbon atoms. Preferably, 12-hydroxy-octadecanoic acid will be selected as the fatty acid.

In G₁ and G₂, each hydrocarbon chain may optionally be substituted by at least one hydroxyl group. The first additive may advantageously be selected from the group consisting in the saturated or unsaturated mono-, di-, tri-, tetra-, penta- and hexa-esters of fatty acid, comprising at least one linear or branched hydrocarbon chain with 4 to 36 carbon atoms, preferably with 4 to 24 carbon atoms, more preferably with 12 to 24 carbon atoms, even more preferably with 16 to 22 carbon atoms. As examples of non-hydroxylated mono-esters of fatty acid, there may be mentioned the alkyl, in particular methyl, ethyl, propyl and butyl, palmitates (C16, saturated), stearates (C18, saturated), oleates (C18, unsaturated), linoleates (C18, unsaturated). As examples of hydroxylated mono-esters of fatty acid, there may be mentioned ethylene glycol monostearate, methyl 12-hydroxystearate, ethyl 12-hydroxystearate, ethylene glycol hydroxystearate and glycerol monohydroxystearate.

The first additive will preferably be selected from the group consisting in the saturated or unsaturated di-, tri-, tetra-, penta- and hexa-esters of fatty acid, comprising at least one linear or branched hydrocarbon chain with 4 to 36 carbon atoms, preferably with 4 to 24 carbon atoms, more preferably with 12 to 24 carbon atoms, even more preferably with 16 to 22 carbon atoms. As examples of di-esters of fatty acid, non-hydroxylated and hydroxylated respectively, there may be mentioned ethylene glycol distearate (non-hydroxylated) and the glycerol diester of bis(12-hydroxyoctadecanoic acid). As examples of tri-esters of fatty acid, non-hydroxylated and hydroxylated respectively, there may be mentioned glycerol tristearate and the glyceryl ester of 12-hydroxyoctadecanoic acid. As examples of tetra- and hexa-esters of fatty acid, there may be mentioned pentaerythritol (PET) tetrastearate and pentaerythritol (PET) tetraisononanoate.

The hydrocarbon chain may advantageously be substituted by at least one hydroxyl group. The derivatives of the glycerides of fatty acids, of hydroxy fatty acids, of pentaerythritol (PET) or dipentaerythritol (diPET) comprising at least one linear or branched hydrocarbon chain with 4 to 36 carbon atoms, preferably with 4 to 24 carbon atoms, more preferably with 12 to 24 carbon atoms, even more preferably with 16 to 22 carbon atoms, will preferably be selected. The first additive is advantageously selected from the group consisting in the mono-, di- and tri-glycerides of fatty acids, the mono-, di- and tri-glycerides of hydroxy fatty acids, the fatty acid mono-, di-, tri- and tetra-esters of pentaerythritol (PET) and the fatty acid mono-, di-, tri-, tetra-, penta- and hexa-esters of dipentaerythritol (diPET), the fatty acids being as described above.

The first additive may preferably be selected from the triglycerides of fatty acids comprising three hydrocarbon chains, identical or different, each independently saturated or unsaturated, linear or branched, with 4 to 36 carbon atoms, preferably with 4 to 24 carbon atoms, more preferably with 12 to 24 carbon atoms, even more preferably with 16 to 22 carbon atoms. The hydrocarbon chain may advantageously be substituted by at least one hydroxyl group. The saturated or unsaturated triglycerides of fatty acid are of vegetable origin or may be obtained by synthesis or modifications of compounds of vegetable origin. Thus, an unsaturated C18 fatty acid triglyceride such as castor oil (triglyceride of ricinoleic acid) may be hydrogenated by any known process, to obtain the triglyceride of 12-hydroxystearic acid corresponding to said saturated fatty acid triglyceride.

The preferred first additive is selected from the mono-, di- or triglyceride of 12-hydroxystearic acid, in particular the triglyceride of 12-hydroxystearic acid of the following formula:

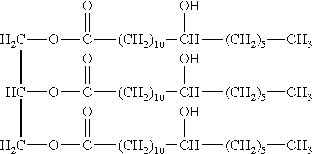

Whatever the type of fatty acid ester of the first additive, saturated fatty acid derivatives will be preferred. Thus, according to a preferred embodiment, a first additive comprising at least one saturated fatty acid ester function will be selected.

The second additive comprises at least one organogelator advantageously having a molecular weight less than or equal to 2000 g·mol⁻¹, preferably less than or equal to 1000 g·mol⁻¹. As explained in the applicant's patent application WO2008107551, by organogelator is meant compounds capable of establishing physical interactions with each other leading to auto-aggregation with formation of a 3D supra-molecular network which is responsible for the gelling of the bitumen. The close packing of the organogelling molecules results in the formation of a network of fibrils, immobilizing the bitumen molecules.

At the temperatures of use, in the range from 10 to 60° C., the organogelators bind to one another non-covalently, in particular by hydrogen bonds. These hydrogen bonds disappear when the bitumen is heated to high temperature. Thus, at the temperatures of use, the organogelator constituted of a large number of organogelators may be assimilated to a “supramolecular” polymer and imparts to the bitumen with improved physical properties, in particular in respect of hardness. At the temperatures of use, gelling due to the aggregation of the organogelling molecules causes thickening of the bituminous medium, leading to an increase in hardness. The bitumen no longer flows under its own weight, and its hardness at the temperatures of use is increased relative to the starting bitumen alone without organogelling additive. When the bituminous composition is heated, the interactions stabilizing the organogelator disappear and the bitumen regains the properties of a bitumen without additive, and the high-temperature viscosity of the bituminous composition is once again the same as that of the starting bitumen.

In the context of the invention, the organogelator comprises at least one hydrogen bond acceptor A and at least one hydrogen bond donor D. For gelling and setting of the bitumen in mass, the organogelator must be soluble at high temperature in the bitumen. The main chemical constituents of bitumen are asphaltenes and maltenes. The asphaltenes are compounds, in particular heterocyclic, constituted by numerous aromatic nuclei and polycondensed naphthene rings. The maltenes in their turn mainly are constituted by long paraffinic chains. Consequently, the organogelator according to the invention also comprises at least one chemical group C compatibilizing the organogelator with the chemical compounds of the bitumen. This compatibilizer C may comprise, alone or in a mixture, a group selected from: at least one long hydrocarbon chain compatible with the maltene fraction of the bitumen, or at least one aliphatic ring with 3 to 8 atoms, or at least one condensed polycyclic system, aliphatic, partially aromatic or entirely aromatic, compatible with the asphaltene fraction of the bitumen, each ring preferably comprising from 5 to 8 atoms.

In the context of the invention, preferably a second additive will be selected having a melting point below 180° C., preferably below 140° C., allowing it to be used at the temperatures of use and of application of the bituminous compositions. The second additive comprises at least one organogelator. The organogelators will be selected from hydrazines, fatty acid diamides, diureas and sorbitol derivatives having at least one hydrogen acceptor function A, at least one hydrogen bond donor D and at least one compatibilizing chemical group C. Examples of organogelators usable in the invention are in particular those described in patent application WO2008107551 and in the article by P. Terech and R. G. Weiss “Low molecular mass gelators of organic liquids and the properties of their gels” (Chem. Rev. 1997, 97, 3133-3159); these two documents being mentioned as examples and incorporated by reference in the present application.

According to a particular embodiment, the second additive comprises at least one organogelator of general formula (I):

R₁—(NH)ₙCONH—(X)ₘ—NHCO(NH)ₙ—R₂ (I)

In formula (I), n and m are integers having a value of 0 or 1 independently of one another.

The groups R₁, R₂ and/or X are identical or different and represent independently a saturated or unsaturated, linear or branched, cyclic or acyclic hydrocarbon chain with 4 to 36 carbon atoms, preferably with 4 to 24 carbon atoms, more preferably with 12 to 24 carbon atoms, even more preferably with 16 to 22 carbon atoms. The hydrocarbon chain may optionally contain at least one heteroatom, for example selected from O, N and S, preferably O.

Moreover, the hydrocarbon chain may also comprise a C₃-C₈ monocyclic aliphatic ring or C₆-C₁₄ condensed polycyclic ring, preferably C₅-C₁₀ and/or a C₅-C₈ monocyclic aromatic ring, preferably C₅-C₆ or C₆-C₁₄ condensed polycyclic ring, preferably C₈-C₁₂. The aliphatic or aromatic rings may optionally contain heteroatoms selected from O, N and S, preferably O. The aliphatic or aromatic, monocyclic or condensed polycyclic rings may optionally be substituted by at least one group selected from halogens, hydroxyl group, primary amine group, sulphydryl group and C₁-C₈ hydrocarbon chains, saturated or unsaturated, linear or branched, optionally comprising at least one heteroatom selected from O, N and S, preferably O. The aliphatic or aromatic, monocyclic or condensed polycyclic rings are preferably substituted by a hydroxyl group and at least one linear or branched, saturated C₁-C₈, preferably C₁-C₄ hydrocarbon chain.

According to a variant, the organogelator comprises a hydrazide unit. The organogelator has a formula (I) in which the integers n and m have a value of 0. In this particular case, the groups R₁—CONH— and —NHCO—R₂ are bound covalently by a hydrazide bond —CONH—NHCO—. The groups R₁ and/or R₂ then constitute the compatibilizer C.

Advantageously, the organogelator is represented by formula (I) in which:
R₁ and R₂ are identical or different and comprise independently a C₅-C₈ monocyclic aromatic ring or C₆-C₁₄ condensed polycyclic ring, preferably C₈-C₁₂, said monocyclic aromatic or condensed polycyclic ring optionally being substituted by at least one group selected from halogens, hydroxyl group, primary amine group, sulphydryl group and C₁-C₈ hydrocarbon chains, linear or branched, saturated or unsaturated, preferably saturated, optionally comprising at least one heteroatom selected from O, N and S, preferably O, and
n and m have a value of 0.

Among the preferred organogelators according to the invention, there may be mentioned 2′,3-bis[[3-[3,5-di-tert-butyl-4-hydroxyphenyl]propionyl]]propionohydrazide of the following formula:

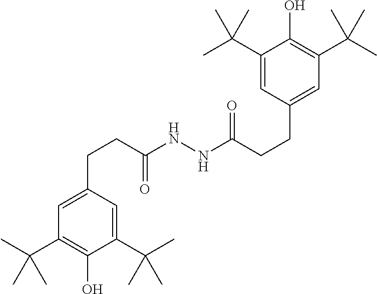 [SMILES: CC(C)(C)c1cc(CCC(=O)NNC(=O)CCc2cc(C(C)(C)C)c(O)c(C(C)(C)C)c2)cc(C(C)(C)C)c1O]

Alternatively, the groups R₁ and R₂, which may be identical or different, are, independently, saturated linear hydrocarbon chains with 4 to 36 carbon atoms, preferably with 4 to 24 carbon atoms, more preferably with 12 to 24 carbon atoms, even more preferably with 16 to 22 carbon atoms. Among the preferred saturated linear hydrocarbon chains, there may be mentioned the groups C₄H₉, C₅H₁₁, C₉H₁₉, C₁₁H₂₃, C₁₂H₂₅, C₁₇H₃₅, C₁₈H₃₇, C₂₁H₄₃, C₂₂H₄₅.

Among the preferred organogelators according to the invention, there may be mentioned the hydrazide derivatives corresponding to the following formulae:

C₅H₁₁—CONH—NHCO—O₅H₁₁

C₉H₁₉—CONH—NHCO—C₉H₁₉

C₁₁H₂₃—CONH—NHCO—C₁₁H₂₃

C₁₇H₃₅—CONH—NHCO—C₁₇H₃₅

C₂₁H₄₃—CONH—NHCO—C₂₁H₄₃

According to another variant, the organogelator has a formula (I) in which the integer n has a value of 0 and the integer m has a value of 1. In this case, the groups R₁, R₂ and/or X constitute the compatibilizer C. The organogelator then comprises two amide units.

The organogelator is preferably a fatty acid diamide represented by formula (I) in which n has a value of 0, m has a value of 1 and X represents the group —(CH₂)ₚ— with p being comprised between 1 and 8, preferably between 1 and 4. Advantageously, the organogelator is represented by formula (I) in which R₁ and R₂ are identical or different and represent independently a linear or branched, saturated acyclic hydrocarbon chain with 4 to 36 carbon atoms, preferably with 4 to 24 carbon atoms, more preferably with 12 to 24 carbon atoms, even more preferably with 16 to 22 carbon atoms, and optionally at least one heteroatom. In particular, N,N′-ethylene-bis(stearamide) of the following formula: C₁₇H₃₅—CONH—CH₂—CH₂—NHCO—C₁₇H₃₅, will be selected as the organogelator.

According to another variant, the organogelator is represented by formula (I) in which the integers n and m have a value of 1. In this case, the groups R₁, R₂ and/or X constitute the compatibilizer C. The organogelator comprises two urea units.

The preferred compounds are the ureide derivatives, one particular urea of which, 4,4′-bis(dodecylaminocarbonylamino)diphenylmethane, has the formula:

C₁₂H₂₅—NHCONH—C₆H₄—CH₂—C₆H₄—NHCONH—C₁₂H₂₅.

According to another particular embodiment, the organogelator is selected from the sorbitol derivatives, and preferably 1,3:2,4-di-O-benzylidene-D-sorbitol. By sorbitol derivative is meant any reaction product obtained from sorbitol. In particular, any reaction product obtained by reacting an aldehyde with sorbitol. This condensation reaction gives sorbitol acetals, which are sorbitol derivatives. For example, 1,3:2,4-di-O-benzylidene-D-sorbitol is obtained by

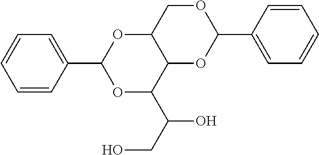 [SMILES: OCC(O)C1OC(c2ccccc2)OC2COC(c3ccccc3)OC21]

reacting one mole of D-sorbitol and two moles of benzaldehyde and has the formula:

All the sorbitol derivatives may thus be products of condensation of aldehydes, in particular aromatic, with sorbitol. Sorbitol derivatives of the following general formula (II) will then be obtained:

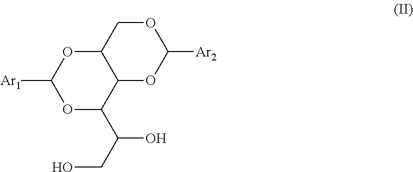

in which Ar₁ and Ar₂ are identical or different and represent independently a C₅-C₈ monocyclic aromatic ring, preferably C₅-C₆ or C₆-C₁₄ condensed polycyclic ring, preferably C₁₀-C₁₄, optionally substituted by at least one group selected from halogens, hydroxyl group, primary amine group, sulphydryl group and C₁-C₈ hydrocarbon chains, linear or branched, saturated or unsaturated, preferably saturated, optionally comprising at least one heteroatom selected from O, N and S, preferably O.

Advantageously, the organogelator is represented by formula (II) in which Ar₁ and Ar₂ are identical or different and represent independently a C₅-C₈ monocyclic aromatic ring, optionally substituted by at least one group selected from halogens, hydroxyl group, primary amine group, sulphydryl group and the C₁-C₈ saturated hydrocarbon chains, linear or branched, optionally comprising at least one heteroatom selected from O, N and S, preferably O. Ar₁ and Ar₂ preferably represent phenyl groups, optionally ortho, meta or para substituted.

Among the sorbitol derivatives, other than 1,3:2,4-di-O-benzylidene-D-sorbitol, there may be mentioned for example 1,3:2,4:5,6-tri-O-benzylidene-D-sorbitol, 2,4-mono-O-benzylidene-D-sorbitol, 1,3:2,4-bis(p-methylbenzylidene) sorbitol, 1,3:2,4-bis(3,4-dimethylbenzylidene) sorbitol, 1,3:2,4-bis(p-ethylbenzylidene) sorbitol, 1,3:2,4-bis(p-propylbenzylidene) sorbitol, 1,3:2,4-bis(p-butylbenzylidene) sorbitol, 1,3:2,4-bis(p-ethoxylbenzylidene) sorbitol, 1,3:2,4-bis(p-chlorobenzylidene) sorbitol, 1,3:2,4-bis(p-bromobenzylidene) sorbitol, 1,3:2,4-di-O-methylbenzylidene-D-sorbitol, 1,3:2,4-di-O-dimethylbenzylidene-D-sorbitol, 1,3:2,4-di-O-(4-methylbenzylidene)-D-sorbitol, 1,3:2,4-di-O-(4,3-dimethylbenzylidene)-D-sorbitol. Instead of sorbitol, using any other polyol, for example xylitol, mannitol and/or ribitol, might be envisaged.

The bituminous compositions according to the invention are constituted by a major part of bitumen and a minor part of the first and second additives. In particular, the bituminous composition advantageously comprises from 0.1 to 10% by weight of the first and second additives relative to the weight of bitumen. The bituminous composition typically comprises from 0.1 to 5.0% by weight of each of the first or second additives, relative to the weight of bitumen. A quantity less than 0.1% weight of the first or second additive might be insufficient to obtain an effect on the rheological properties of the bituminous composition according to the invention, as the constituent molecules of the first and second additives would be too distant from one another to interact.

Conversely, a quantity above 5.0% by weight could impair the properties of the bitumen base or bituminous composition. The bituminous composition advantageously comprises from 0.5 to 3% by weight, preferably from 1 to 2% by weight of the first additive relative to the weight of bitumen. The bituminous composition advantageously comprises from 0.5 to 3% by weight, preferably from 1 to 2% by weight of the second additive relative to the weight of bitumen.

According to a preferred embodiment, the second additive contains at least 50% by weight of the organogelator, preferably at least 80%. The second additive is advantageously constituted by the organogelator, apart from some impurities conventionally present in such compounds, but not exceeding 2 to 3%. The weight ratio of the first additive to the second additive is preferably comprised between 5:0.1 and 0.1:5, preferably between 2:0.2 and 0.2:2.

Other conventional additives may also be added to a bituminous composition according to the invention. These are, for example, vulcanizing agents and/or cross-linking agents that are able to react with a polymer, when it is an elastomer and/or a plastomer that may be functionalized and/or that may comprise reactive sites. Among the vulcanizing agents, there may be mentioned those based on sulphur and derivatives thereof, used for cross-linking an elastomer at contents from 0.01% to 30% relative to the weight of elastomer.

Among the cross-linking agents, there may be mentioned the cationic cross-linking agents such as the mono- or poly-acids, or carboxylic anhydrides, esters of carboxylic acids, sulphonic, sulphuric, phosphoric acids, or even the acid chlorides, and phenols, at contents from 0.01% to 30% relative to the polymer. These agents are able to react with the functionalized elastomer and/or plastomer. They may be used to supplement or to replace the vulcanizing agents.

The invention also relates to a method of preparing a bituminous composition as described above, hard at the temperatures of use and of low viscosity when hot. The first and second additives described above may equally well be added to the bitumen alone, or during manufacture of bitumens, bitumen mixes, binders or dressings. The first and second additives are added to the bitumen, whether or not modified with polymers, to the bitumen in the form of bituminous binder or to the bitumen when the latter is in the form of anhydrous binder, synthetic binder, bituminous mixes, or surface dressing, but always hot, at temperatures in the range from 100 to 180° C., preferably 120° C. to 140° C. The first and second additives may be introduced separately or as a mixture; the order of introduction does not have any particular influence on the properties of the bituminous composition thus obtained. The mixtures may then be stirred at these temperatures until the first and second additives have dissolved in the bitumen, polymeric bitumen, bituminous binder, a synthetic binder, binder in anhydrous form or in the form of a bituminous mix.

### Examples

The invention is illustrated by the following examples, given as an illustration and non-limitatively. The rheological and mechanical characteristics of the bitumen bases or bituminous compositions referred to in these examples are measured in the manner indicated in Table 1. Moreover, the Brookfield viscosity is expressed in mPa·s. The viscosity is measured by means of a Brookfield CAP 2000+ viscosimeter. It is measured at 80° C. and 120° C. and at a rotary speed of 15 rev/min and 400 rev/min, respectively. The measurement is read after 30 seconds for each temperature.

TABLE 1

| | | | Measurement |
|---|---|---|---|
| Property | Abbreviation | Unit | standard |
| Needle penetration at 25° C. | P₂₅ | 1/10 mm | EN 1426 |
| Ring and ball softening point | RBT | ° C. | EN 1427 |
| Brookfield viscosity | — | MPa · s | Cf. examples |

Starting Products:

Bitumen Bases:

Direct distillation bitumen, designated B₀, of class 70/100 and with penetration at 25° C. of 74 1/10 mm the characteristics of which comply with standard EN 12591.

Direct distillation bitumen, designated B₁, of class 50/70 and with penetration at 25° C. of 59 1/10 mm the characteristics of which comply with standard EN 12591.

First Additive:

triglyceride of 12-hydroxystearic acid, designated A₁,

castor oil, designated A₂,

methyl stearate, designated A₃,

PET tetraisononanoate, designated A₄.

Second Additive:

1,3:2,4-di-O-benzylidene-D-sorbitol, designated O₁,

N,N′-ethylene-bis(stearamide), designated O₂,

2′,3-bis[[3-[3,5-di-tert-butyl-4-ydroxyphenyl]propionyl]]propionohydrazide, designated O₃.

Preparation of the Bituminous Compositions

First the bitumen is put in the reactor. Then the first and second additives are added. The reaction mixture is then stirred until a homogeneous final appearance is obtained (about 60 minutes). The mixture is then cooled to ambient temperature.

The results are presented in Table 2 below:

TABLE 2

| | Bituminous composition | | | | | | | | |
|---|---|---|---|---|---|---|---|---|---|
| | first | second | | % by | | | | | |
| | additive | additive | | weight | | Index | | Viscosity | Viscosity |
| Ref. | (Aₓ) | (Oₓ) | Bitumen base | Aₓ/Oₓ | P₂₅ | PI | RBT | 80° C. | 120° C. |
| B⁰ | — | — | B₀ | | 74 | −1.05 | 47 | 12725 | 685 |
| T⁰_{A1} | A₁ | — | B₀ | 3 | 77 | −1.24 | 46 | 8360 | 528 |
| T⁰_{A1}′ | A₁ | — | B₀ | 2 | 76 | −0.98 | 47 | 9200 | 568 |
| T⁰_{O1} | — | O₁ | B₀ | 0.4 | 45 | 6.37 | 100 | 14400 | 705 |
| C⁰_{A1/O2} | A₁ | O₁ | B₀ | 3/0.4 | 50 | 7.86 | 113.5 | 9300 | 540 |
| T⁰_{O2} | — | O₂ | B₀ | 2.0 | 50 | 5.85 | 92.4 | 17200 | 585 |
| C⁰_{A1/O2} | A₁ | O₂ | B₀ | 3/2.0 | 49 | 5.92 | 93.5 | 10300 | 439 |
| C⁰_{A1/O2}′ | A₁ | O₂ | B₀ | 2/2.0 | 52 | 6.34 | 96 | 11800 | 480 |
| T⁰_{O3} | — | O₃ | B₀ | 0.7 | 53 | 6.29 | 95 | 17600 | 696 |
| C⁰_{A1/O3} | A₁ | O₃ | B₀ | 3/0.7 | 52 | 6.50 | 97.5 | 9200 | 530 |
| T⁰_{A2} | A₂ | — | B₀ | 3 | 125 | −0.97 | 42.4 | 7450 | 448 |
| T⁰_{O2} | — | O₂ | B₀ | 2.0 | 50 | 5.85 | 92.4 | 17200 | 585 |
| C⁰_{A2/O2} | A₂ | O₂ | B₀ | 3/2.0 | 80 | 7.29 | 93 | 10250 | 443 |
| T⁰_{O1} | — | O₁ | B₀ | 0.4 | 45 | 6.37 | 100 | 14400 | 705 |
| C⁰_{A2/O1} | A₂ | O₁ | B₀ | 3/0.4 | 70 | 9.28 | 120 | 8650 | 508 |
| T⁰_{A3} | A₃ | — | B₀ | 3 | >185 | −1.55 | 37.5 | 5625 | 409 |
| T⁰_{O2} | — | O₂ | B₀ | 2.0 | 50 | 5.85 | 92.4 | 17200 | 585 |
| C⁰_{A3/O2} | A₃ | O₂ | B₀ | 3/2.0 | 120 | 5.99 | 72 | 6780 | 348 |
| T⁰_{O1} | — | O₁ | B₀ | 0.4 | 45 | 6.37 | 100 | 14400 | 705 |
| C⁰_{A3/O1} | A₃ | O₁ | B₀ | 3/0.4 | 102 | 9.58 | 109 | 6500 | 429 |
| B¹ | — | — | B₁ | | 59 | −1.45 | 47.6 | 14550 | 760 |
| T¹_{A1} | A₁ | — | B₁ | 3 | 58 | −1.22 | 48.6 | 9750 | 594 |
| T¹_{O1} | — | O₁ | B₁ | 0.4 | 39 | 4.08 | 83 | 19400 | 889 |
| C¹_{A1/O1} | A₁ | O₁ | B₁ | 3/0.4 | 44 | 7.24 | 110 | 12000 | 628 |
| T¹_{A4} | A₄ | — | B₁ | 3 | 89 | −0.66 | 46.6 | 11750 | 636 |
| C¹_{A4/O1} | A₄ | O₁ | B₁ | 3/0.4 | 53 | 7.19 | 104 | 12950 | 660 |

Needle penetration, measured at 25° C., is expressed in 1/10 mm. The ring and ball softening point is expressed in ° C. The Brookfield viscosity, measured at 80° C. and 120° C., is expressed in mPa·s.

The Pfeiffer penetration index is defined by the following calculation formula:

$$PI = \frac{1952 - 500 \times log ( {P}_{25} ) - 20 \times RBT}{50 \times log ( {P}_{25} ) - RBT - 120}$$

The results presented in Table 2 show a synergistic effect resulting from the combination of the first additive and of the second additive. In fact, regardless of the nature of the first additives A₁, A₂, A₃ or A₄ or of the second additives O₁, O₂ or O₃, it can be seen that the PI value of the bituminous composition comprising such a combination is greater than the PI value of the bitumen base alone B₀ or B₁, the bitumen base with the first additive or the bitumen base with the second additive. Thus, for example, the PI of the composition C⁰_{A1/O1} amounts to 7.86 whereas the PI of the bitumen base T₀ is −1.05 and the PI values of the control compositions T⁰_{A1} and T⁰_{O1} are −1.24 and 6.37 respectively.

Moreover, an identical synergistic effect is observed on the RBT, with the exception of the composition C⁰_{A3/O2}. These results would tend to prove that the synergistic effect on the RBT is promoted by the presence of several fatty acid ester functions or several hydrocarbon chains comprising at least 4 carbon atoms in the first additive.

A synergistic effect is also observed on the hardness of the compositions C⁰_{A1/O2} and C⁰_{A1/O3}. The bituminous compositions C⁰_{A1/O2} and C⁰_{A1/O3} have a penetration at 25° C. of 93.5 and 97.5° C. respectively, below the penetration value of the bitumen base B⁰ (47° C.) or of the corresponding control compositions T⁰_{A1}, T⁰_{O2} and T⁰_{O3}, of 46, 92.4 and 95° C. respectively.

Finally, a remarkable effect is also observed on the dynamic viscosity of the compositions C⁰_{A1/O2}, C⁰_{A1/O2′} and C⁰_{A2/O2}. The bituminous compositions C⁰_{A1/O2}, C⁰_{A1/O2′} and C⁰_{A2/O2} have a dynamic viscosity at 120° C. of 439, 480 and 443 mPa·s respectively, below the dynamic viscosity value of the bitumen base B⁰ (685 mPa·s) or of the corresponding control compositions T⁰_{A1}, T⁰_{A1′}, T⁰_{A2} and T⁰_{O2}, of 528, 658, 448 and 585 mPa·s respectively, without impairing the consistency, in particular the PI of said compositions. Thus, appropriate selection of the first additive and of the second additive makes it possible to adjust the mechanical and rheological properties of the bituminous composition or the bitumen base according to the application for which it is intended.

These results provide evidence of a significant thermoreversible effect due to the simultaneous presence of the first and second additives in the bitumen base or bituminous composition. Interaction of the first and second additives is reflected in an appreciable decrease in high-temperature viscosity. Within the bituminous combination, combining the first and second additives induces specific rheological properties that go beyond the intrinsic properties of each of the first and second additives taken separately.

Another aspect of the invention consequently relates to the use of a combination of a first additive and a second additive as described above in a bituminous composition, to improve the mechanical and rheological properties, in particular the susceptibility to temperature of the bituminous composition or bitumen base. As is evidenced by the examples described above, the applicant discovered that the use of this specific combination of the first and second additives of the invention in a bituminous composition or in a bitumen base makes it possible to increase the penetration index (or Pfeiffer index, PI) of said composition or bitumen base. This increase is all the more surprising in that the PI value obtained for a bituminous composition or bitumen base with these additives is greater not only than the composition or bitumen base alone but also than the PI value obtained on compositions or bitumen bases containing independently the first additive alone or the second additive alone. These results reflect a synergistic effect resulting from the specific combination of the first additive and of the second additive.

The applicant has also demonstrated an equivalent synergistic effect for the RBT. The use of such a combination significantly increases the RBT of a bituminous composition or of a bitumen base while maintaining a low viscosity at the temperature of application, in particular at a temperature above or equal to 80° C., preferably above 80° C. Moreover, the use of such a combination in a bitumen base or a bituminous composition gives a significant decrease in needle penetration at 25° C. ( 1/10 mm) according to standard EN 1426 when the organogelator of the second additive is represented by formula (I).

Finally, the use of such a combination in a bitumen base or a bituminous composition advantageously produces both an increase in the RBT and PI and a decrease in the dynamic viscosity of the bituminous composition or bitumen base, at a temperature above or equal to 80° C., preferably above 80° C. In particular, when the organogelator of the second additive comprises two amide units and is represented by formula (I) in which n has a value of 0 and m has a value of 1, it was shown that jointly with the increase in PI and RBT, the use of the combination of additives according to the invention also lowers the dynamic viscosity of the bituminous composition or bitumen base, at a temperature above or equal to 80° C., preferably above 80° C. The bituminous compositions comprising such a combination combine high-performance mechanical properties at the temperature of use and low susceptibility to temperature at the temperature of application.

Various uses of the bituminous compositions obtained according to the invention are envisaged, in particular for manufacture of a bituminous binder, in particular a synthetic binder, an anhydrous binder, a bituminous emulsion, a polymeric bitumen or a fluxed bitumen, which may in its turn be used for preparing a combination with aggregates, in particular highway aggregates. Another aspect of the invention is the use of a bituminous composition in various industrial applications, in particular for preparing a sealing coating, a membrane or a prime coat. With regard to highway applications, the invention relates in particular to bituminous mixes as materials for the construction and maintenance of pavement systems and their covering as well as for carrying out all road works. The bituminous mix comprises a bituminous composition as described above, coating aggregates of bituminous mixes and mineral and/or synthetic fillers.

Thus, the invention relates for example to surface dressings, hot bituminous mixes, cold bituminous mixes, cold poured bituminous mixes, emulsion-gravel mixtures, base courses, binder courses, bonding courses and surfacing, and other combinations of a bituminous binder and highway aggregates having particular properties, such as anti-rut courses, bituminous mixes for drainage or asphalts (mixture of a bituminous binder with aggregates of the sand type). Regarding the industrial applications of the bituminous compositions, there may be mentioned the manufacture of sealing membranes, anti-noise membranes, isolating membranes, surface coverings, carpet slabs, prime coats. The present invention is remarkable in that it proposes a bituminous binder that can be used for manufacturing asphaltic or bituminous products at temperatures of manufacture and implementation that are low enough to eliminate or at the very least greatly reduce the emissions of fumes while preserving the mechanical properties of the asphaltic or bituminous products obtained.

1-23. (canceled)

24. A thermoreversibly cross-linked bituminous composition comprising:
a bitumen;
a first additive comprising at least one fatty acid ester function, saturated or unsaturated, having a hydrocarbon chain with 4 to 36 carbon atoms, linear or branched;
a second additive comprising at least one organogelator of the following general formula (I) or (II):
R₁—(NH)ₙCONH—(X)ₘ—NHCO(NH)ₙ—R₂ (I)
in which:
the groups R₁, R₂ and/or X are identical or different and represent independently a saturated or unsaturated, linear or branched, cyclic or acyclic hydrocarbon chain with 4 to 36 carbon atoms and optionally at least one heteroatom; and
n and m are integers having a value of 0 or 1 independently of one another;
sorbitol derivatives of the following general formula (II): 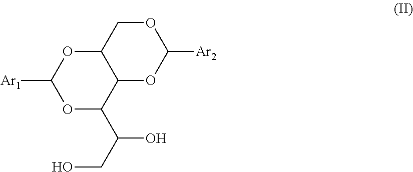
in which Ar₁ and Ar₂ are identical or different and represent independently a C₅-C₈ monocyclic aromatic ring or C₆-C₁₄ condensed polycyclic ring.

25. The composition according to claim 24, wherein the first additive has a general formula (III) as follows: 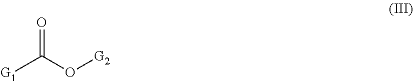
in which
G₁ represents a saturated or unsaturated, linear or branched aliphatic hydrocarbon chain with 4 to 36 carbon atoms; and
G₂ represents a saturated or unsaturated, linear or branched aliphatic hydrocarbon chain with 1 to 188 carbon atoms.

26. The composition according to claim 25, wherein G₂ comprises at least one ester function.

27. The composition according to claim 24, wherein the first additive is selected from the group consisting in the saturated or unsaturated mono-, di-, tri-, tetra-, penta- and hexa-esters of fatty acid, comprising at least one linear or branched hydrocarbon chain with 4 to 36 carbon atoms.

28. The composition according to claim 27, wherein the first additive is selected from the group consisting in the mono-, di- and tri-glycerides of fatty acids, the mono-, di- and tri-glycerides of hydroxy fatty acids, the fatty acid mono-, di-, tri- and tetra-esters of pentaerythritol (PET) and the fatty acid mono-, di-, tri-, tetra-, penta- and hexa-esters of dipentaerythritol (diPET).

29. The composition according to claim 28, wherein the first additive is selected from the triglycerides of fatty acids comprising three hydrocarbon chains, identical or different, each independently saturated or unsaturated, linear or branched, with 4 to 36 carbon atoms.

30. The composition according to claim 24, wherein the organogelator is represented by formula (I), in which n and m have a value of 0, and comprises a hydrazide unit.

31. The composition according to claim 30, wherein the organogelator is represented by formula (I) in which R₁ and R₂ are identical or different and comprise independently a C₅-C₈ monocyclic aromatic ring or C₆-C₁₄ condensed polycyclic, said monocyclic aromatic or condensed polycyclic ring.

32. The composition according to claim 24, wherein the organogelator comprises two amide units and is represented by formula (I) in which the integer n has a value of 0 and the integer m has a value of 1.

33. The composition according to claim 32, wherein the organogelator is a fatty acid diamide represented by formula (I) in which n has a value of 0, m has a value of 1 and X represents the group —(CH₂)ₚ— with p being comprised between 1 and 8.

34. The composition according to claim 33, wherein the organogelator is represented by formula (I) in which R₁ and R₂ are identical or different and represent, independently, a saturated, acyclic, linear or branched hydrocarbon chain with 4 to 36 carbon atoms.

35. The composition according to claim 24, wherein the organogelator is represented by formula (I), in which the integers n and m have a value of 1, and comprises two urea units.

36. The composition according to claim 24, wherein the organogelator is represented by formula (II) in which Ar₁ and Ar₂ are identical or different and represent independently a C₅-C₈ monocyclic aromatic ring.

37. The composition according to claim 24, wherein it comprises from 0.1 to 10% by weight of the first and second additives relative to the weight of bitumen.

38. The composition according to claim 24, further comprising aggregates of bituminous mixes and mineral and/or synthetic fillers.

39. A bituminous binder in the form of a synthetic binder, an anhydrous binder, a bituminous emulsion, a polymeric bitumen or a fluxed bitumen, comprising a bituminous composition comprising:
a bitumen;
a first additive comprising at least one fatty acid ester function, saturated or unsaturated, having a hydrocarbon chain with 4 to 36 carbon atoms, linear or branched;
a second additive comprising at least one organogelator of the following general formula (I) or (II):
R₁—(NH)ₙCONH—(X)ₘ—NHCO(NH)ₙ—R₂ (I)
in which:
the groups R₁, R₂ and/or X are identical or different and represent independently a saturated or unsaturated, linear or branched, cyclic or acyclic hydrocarbon chain with 4 to 36 carbon atoms and optionally at least one heteroatom; and
n and m are integers having a value of 0 or 1 independently of one another;
sorbitol derivatives of the following general formula (II): 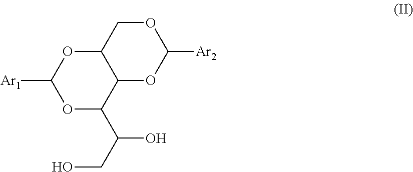
in which Ar₁ and Ar₂ are identical or different and represent independently a C₅-C₈ monocyclic aromatic ring or C₆-C₁₄ condensed polycyclic ring.

40. A method for thermoreversibly cross-linking a bituminous composition or a bitumen base, comprising introducing a combination of a first additive and a second additive in the bituminous composition or the bitumen base, the composition or base comprising:
a bitumen;
a first additive comprising at least one fatty acid ester function, saturated or unsaturated, having a hydrocarbon chain with 4 to 36 carbon atoms, linear or branched;
a second additive comprising at least one organogelator of the following general formula (I) or (II):
R₁—(NH)ₙCONH—(X)ₘ—NHCO(NH)ₙ—R₂ (I)
in which:
the groups R₁, R₂ and/or X are identical or different and represent independently a saturated or unsaturated, linear or branched, cyclic or acyclic hydrocarbon chain with 4 to 36 carbon atoms and optionally at least one heteroatom; and
n and m are integers having a value of 0 or 1 independently of one another;
sorbitol derivatives of the following general formula (II): 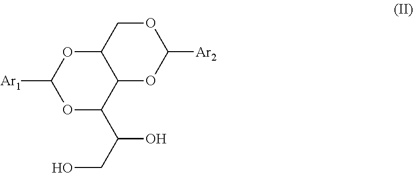
in which Ar₁ and Ar₂ are identical or different and represent independently a C₅-C₈ monocyclic aromatic ring or C₆-C₁₄ condensed polycyclic ring.

41. The method for increasing a penetration index (or Pfeiffer index, PI) of a bituminous composition or a bitumen base, comprising introducing a combination of the first additive and the second additive as described in claim 24 in the bituminous composition or the bitumen base.

42. The method according to claim 41, for increasing a softening point determined by a ring and ball test according to standard EN 1427 (RBT) of the bituminous composition or the bitumen base, comprising introducing the combination of the first additive and the second additive in the bituminous composition or the bitumen base.

43. The method according to claim 41 for decreasing a needle penetration at 25° C., calculated according to standard EN 1426 of the bituminous composition or the bitumen base, comprising introducing the combination of the first additive and the second additive in the bituminous composition or the bitumen base.

44. The method according to claim 43, in which the first additive or the second additive organogelator introduced is represented by general formula (I).

45. The method according to claim 41, for increasing a softening point determined by a ring and ball test according to standard EN 1427 (RBT) and the penetration index (or Pfeiffer index, PI), and for lowering a dynamic viscosity at a temperature above or equal to 80° C. of the bituminous composition or the bitumen base, comprising introducing the combination of the first additive and the second additive in the bituminous composition or the bitumen base.

46. The method of preparing the bituminous composition according to claim 24, wherein the first and second additives are added, at temperatures in the range from 100 to 180° C., either to the bitumen alone, to the bitumen whether or not modified with polymers, to the bitumen in the form of bituminous binder or to the bitumen when the latter is in the form of synthetic binder, anhydrous binder, bituminous mix, or surface dressing, or during manufacture of the bitumen, bituminous mixes, binders or dressings.

47. The composition according to claim 33, wherein p is an integer between 1 and 4.
